(19) United States
(12) Patent Application Publication
(10) Pub. No.: US 2026/0264747 A1
(43) Pub. Date: Sep. 10, 2026

(54) Steering Assistance Method and Control Device for a Vehicle comprising Individual Wheel Steering Actuators

(71) Applicant: Robert Bosch GmbH, Stuttgart (DE)

(72) Inventors: Christian Riese, Stuttgart (DE); Thomas Kurz, Roemerberg (DE); Matthias Ehrmann, Neuhausen (DE); Jonas Coesfeld, Stuttgart (DE); Tobias Ritz, Leonberg (DE)

(21) Appl. No.: 19/162,944

(22) PCT Filed: Feb. 15, 2024
(86) PCT No.: PCT/EP2024/053896

§ 371 Date: Sep. 7, 2025

(30) Foreign Application Priority Data
Mar. 10, 2023 (DE) 10 2023 202 144.7

(51) Int. Cl. B62D 6/00; B62D 9/00

(52) U.S. Cl. CPC B62D 6/002; B62D 9/002

(57) ABSTRACT

The present invention relates to a steering assistance method for a vehicle (100) comprising individual wheel steering actuators, wherein the steering angle difference (120) between a wheel (118) on the inside of the bend and a wheel (116) on the outside of the bend of an axle (104) of the vehicle (100) is set to be smaller in a driving mode in which the axle (104) is being pulled than in a driving mode in which the axle (104) is being pushed.

### FIELD OF THE INVENTION

The invention relates to a steering assistance method for a vehicle comprising individual wheel steering actuators, a corresponding control device and a corresponding computer program.

### PRIOR ART

To steer a vehicle, a right wheel and a left wheel on an axle are traditionally steered by a steering wheel of the vehicle using a common steering gear. In a “steer-by-wire” embodiment of the steering system, a mechanical connection between the steering wheel and the steering gear is omitted. Steering movements are converted to electrical signals at the steering wheel and transmitted to an actuator having a corresponding steering gear. The right and left wheels are generally further steered by a common steering gear. In order to be able to dispense with a mechanical connection between the right wheel and the left wheel, steering systems of each wheel can be steered by an individual wheel steering actuator in the case of “steer-by-wire”.

A steering angle difference can be set between a wheel on the inside of the bend of an axle of a vehicle and wheel on the outside of the bend of the axle during steering to allow both wheels to roll on a circular path around an instantaneous center of rotation of the vehicle. The steering angle difference can be determined according to Ackermann in order to allow the wheels to roll as slip-free as possible with low rolling resistance and tire protection.

An apparatus for setting the steering angle difference may be designed into the kinematics of a steering linkage of the wheels. Alternatively, the wheels may be steered by individual wheel steering actuators. The steering angle difference can be freely provided electronically. The steering angle difference may increase with increasing steering angle. The steering angle difference may also be set differently from Ackermann.

A turning circle of the vehicle is pre-determined by a maximum steering angle of the wheel on the inside of the bend.

### DISCLOSURE OF THE INVENTION

With this in mind, the approach presented here introduces a steering assistance method for a vehicle with individual wheel steering actuators, a corresponding control device and a corresponding computer program according to the independent claims. Advantageous further developments and improvements of the approach presented here will emerge from the description and are described in the dependent claims.

### Advantages of the Invention

In the case of individual wheel steering actuators, the steering angles on the wheel on the inside of the bend and the wheel on the outside of the bend can be set independently of each other. The steering angle difference can thus also be freely set.

Particularly at large steering angles, i.e., during maneuvering and during slow travel, the turning circle of the vehicle can be reduced if the steering angle difference according to Ackermann is significantly undershot. However, if the steering angle difference differs significantly from the steering angle difference according to Ackermann, a driving behavior of the vehicle will be significantly influenced, i.e., possibly negatively noticeable for a driver of the vehicle.

It has been found that an extent and/or manner in which the vehicle responds to the reduced steering angle difference is further dependent on whether the steered axle is being pushed or pulled, i.e., whether the steered axle is in front or behind in the direction of travel during the current driving mode.

In the approach presented herein, the steering angle difference is set to be smaller with the axle being pulled than with the axle being pushed. In a vehicle with, for example, rear wheel drive, the steering angle difference on the steered front axle is thus set smaller for reverse travel, more in the direction of parallel driving, than for forward travel. For reverse travel, the steering angle difference can be set to zero, i.e., the same steering angle can be set on the wheel on the outside of the bend as on the wheel on the inside of the bend.

By the approach presented herein, a smaller turning circle of the vehicle may be achieved. By differentiating the steering angle difference, the vehicle may demonstrate a similar steering behavior to a vehicle having a second steered axle, in particular a steered rear axle.

A steering assistance method for a vehicle comprising individual wheel steering actuators is proposed, wherein the steering angle difference between a wheel on the inside of the bend and a wheel on the outside of the bend of an axle of the vehicle is set to be smaller in a driving mode in which the axle is being pulled than in a driving mode in which the axle is being pushed.

Ideas concerning embodiments of the present invention may be regarded as being based, among other things, on the thoughts and findings described below.

An individual wheel steering actuator may act on a steerable wheel via a tie rod. A mechanical connection between the tie rods may be dispensed with on an axle with individual wheel steering actuators. An individual steering angle can be set on both wheels of the axle. A steering angle difference may be a difference between the steering angle of the wheel on the inside of the bend and the steering angle of the wheel on the outside of the bend. If the wheel on the outside of the bend has the same steering angle as the wheel on the inside of the bend, the steering angle difference is equal to zero.

An axle is pulled if it is arranged at the rear of the vehicle in the direction of travel. For example, the front axle is the axle being pulled for reverse travel. In a rear wheel drive vehicle, the front axle is a free-wheeled axle being pulled for reverse travel. The approach presented here can be particularly advantageous for a free-wheeling or at least substantially free-wheeling axle being pulled, i.e., a not-driven or only slightly driven axle.

In particular, the steering angle difference may be set smaller than a steering configuration in which the steering angle difference is optimized for rolling the wheel on the inside of the bend and the wheel on the outside of the bend with minimum slip on circular tracks about an instantaneous center of rotation of the vehicle. The latter steering configuration represents a setting of the steering angle difference in accordance with Ackermann's teaching, which is typically the basis for steering systems with a central actuator (auxiliary force or by-wire). By setting the steering angle difference smaller than such a slip-optimized steering configuration, the slip on at least one of the steered wheels increases, but a reduced curve radius may be achieved.

A drive balance of the vehicle may be set such that an axis of the vehicle being pulled is driven less strongly than an axis of the vehicle being pushed. For example, the drive balance may be set to generate a substantially free-wheeling axle being pulled. A drive balance may indicate a distribution of drive torque between the front axle and the rear axle in a four-wheel driven vehicle. The drive balance may be set with a mechanical all-wheel drive via a controllable clutch between the front axle and the rear axle. For an electrical all-wheel drive, the at least one drive motor of the rear axle in the direction of travel may be at least reduced to generate the substantially free-wheeling axle being pulled. In this case, the drive torque can be applied to the front axle for forward travel and the drive torque can be applied to the rear axle for reverse travel.

The steering angle difference may be set depending on speed. The steering angle difference may be reduced at a decreasing speed of the vehicle. The slower the vehicle travels, the less disruptive the effect of a steering angle difference that is smaller than a steering angle difference setting according to Ackermann generally is. As speed increases, unwanted effects of the decreased steering angle difference may increase.

The steering angle difference may be set when a speed of the vehicle is less than a slow travel value. The steering angle difference may be reduced below a slow travel speed defined by the slow travel value. For example, the slow travel speed may be less than 50 km/h, less than 30 km/h, less than 20 km/h, or less than 10 km/h. The steering angle difference may in particular be reduced for maneuvering and parking at low speeds.

Furthermore, a longitudinal torque difference between a wheel on the inside bend of the axle and a wheel on an outside bend of the axle may be set on at least one axle of the vehicle. The longitudinal torque difference may be set by a braking torque applied to the wheel on the inside of the bend and/or by a driving torque applied to the wheel on the outside of the bend. The wheel on the inside of the bend can therefore be braked and/or the wheel on the outside of the bend may be accelerated. The longitudinal torque difference causes a yaw moment on the axis. The yaw moment assists in cornering the vehicle and pulls or pushes the vehicle into the curve.

The longitudinal torque difference may be set on a different axle than the steering angle difference. In particular, drive torque may only be provided on a driven axle. An effect of the longitudinal torque difference on the axle being pushed may be greater than on the axis being pulled.

The method is preferably computer-implemented and can be implemented in software or hardware, for instance, or in a mixed form of software and hardware, for example in a driver assistance system.

The approach presented here also creates a control device, wherein the control device is configured to carry out, control or implement the steps of a variant of the method presented here in corresponding devices.

The control device can be an electrical device comprising at least one computing unit for processing signals or data, at least one memory unit for storing signals or data and at least one interface and/or communication interface for reading in or outputting data embedded in a communication protocol. The computing unit can, for instance, be a signal processor, a so-called system ASIC or a microcontroller for processing sensor signals and outputting data signals as a function of the sensor signals. The memory unit can be a flash memory, an EPROM or a magnetic memory unit, for example. The interface can be configured as a sensor interface for reading in the sensor signals from a sensor and/or as an actuator interface for outputting the data signals and/or control signals to an actuator. The communication interface can be configured to read in or output the data wirelessly and/or by wire. The interfaces can also be software modules that are provided on a microcontroller alongside other software modules, for example.

Also advantageous is a computer program product or computer program with program code which is stored on a machine-readable carrier or storage medium, e.g., a semi-conductor memory, a hard disk memory, or an optical memory and used in order to perform, implement and/or control the steps of the method according to one of the embodiments described above, in particular if the program product or program is executed on a computer or a device.

It should be noted that some of the possible features and advantages of the invention are described here with reference to different embodiments. A person skilled in the art will recognize that the features of the control device and the method can be suitably combined, adapted, or interchanged to arrive at further embodiments of the invention.

### BRIEF DESCRIPTION OF THE DRAWINGS

Embodiments of the invention are described in the following with reference to the accompanying drawings, wherein neither the drawings nor the description are to be construed as limiting the invention:

FIG. 1 illustrates a representation of a vehicle when using a steering assistance method in accordance with an exemplary embodiment; and

FIG. 2 shows a representation of a relationship between a steering angle difference and a turning circle in a steering assistance method according to an exemplary embodiment.

The figures are merely schematic and are not to scale. Identical reference signs denote identical or functionally identical features.

### EMBODIMENTS OF THE INVENTION

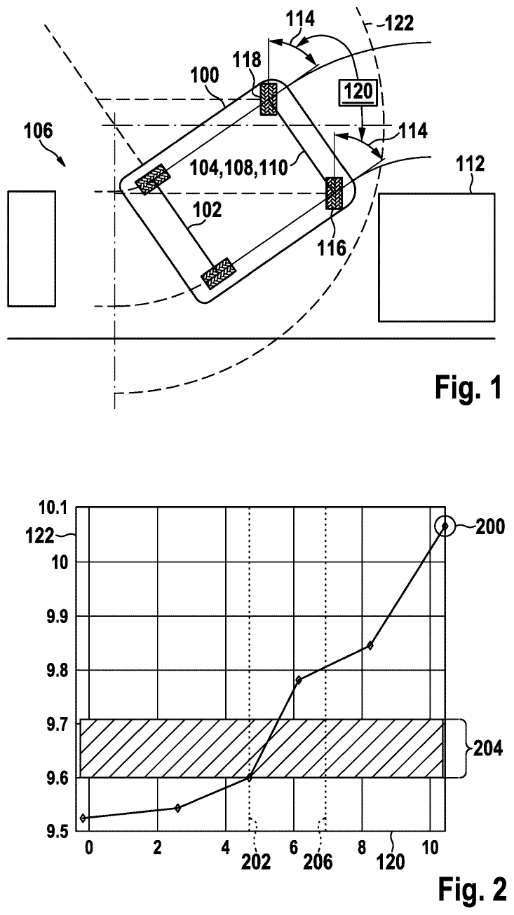

FIG. 1 illustrates a representation of a vehicle 100 when using a steering assistance method in accordance with an exemplary embodiment. The vehicle 100 includes a driven, non-steerable rear axle 102 and a non-driven, steerable front axle 104. The vehicle 100 is here maneuvering and parking in reverse into a parking space 106 parallel to the road. For reverse travel, the front axle 104 is an axle 108 being pulled. For forward travel, the front axle 104 is an axle 110 being pushed.

For parking, the vehicle 100 started next to a front vehicle 112 parked in front of the parking space 106 in the direction of travel and reversed into the parking space 106. The vehicle 100 approaches the curb of the parking space 106 at an angle. A front of the vehicle 100 has passed a rear of the front vehicle 112, and the vehicle 100 steers in the opposite direction as much as possible in order to align the vehicle 100 substantially parallel to the curb again.

The steering assistance method presented herein is used at least for counter-steering. A steering angle 114 of the right and left front wheel, i.e., the wheel 116 on the inside of the bend and the wheel 118 on the outside of the bend is set on the front axle 108 being pulled with a smaller steering angle difference 120 than would be required for a low-slip rolling on circular bends according to Ackermann for the vehicle 100. Thus, a larger steering angle 114 is set at the wheel 116 on the outside of the bend than according to Ackermann. As a result, an instantaneous turning circle 122 of the vehicle 100 decreases relative to the turning circle according to Ackermann. A slightly higher slip results on the wheel 116 on the outside of the bend and on the wheel 118 on the inside of the bend.

The steering angle difference 120 may be set significantly less for the axle 108 being pulled than for the axle 110 being pushed, without the response of the vehicle 100 being unpleasant for vehicle occupants.

If the vehicle 100 drives forwards for the second parking maneuver after the first maneuver and the front axle 104 becomes the axle 110 pushed, the steering angle difference 120 is set larger than for the first parking maneuver driven in reverse with the axle 108 being pulled.

FIG. 2 shows a representation of a relationship between a steering angle difference 120 and a turning circle 122 in a steering assistance method according to an exemplary embodiment. The steering angle difference 120 depicts a difference between a steering angle of a wheel on the outside of the bend of an axle of a vehicle and a steering angle of a wheel on the inside of the bend of the axis of the vehicle. The steering angle difference 120 is plotted on the abscissa of a graph. The turning circle 122 is plotted on the ordinate of the graph. The steering angle difference 120 is plotted from below zero degrees to above ten degrees. The graph shows a relationship between the steering angle difference 120 and the turning circle 122 according to Ackermann 200 with a turning circle 122 between ten meters and 10.1 meters and a steering angle difference 120 of more than 10 degrees at the rightmost measuring point 200 indicated in the diagram. For the steering angle difference 120 according to Ackermann 200, the wheel on the inside of the bend and the wheel on the outside of the bend roll largely without slippage on circular paths around an instantaneous center of rotation of the vehicle.

A reduction of the steering angle difference 120 compared to Ackermann 200 causes a reduction of the turning circle 122 compared to Ackermann 200. For example, the steering angle difference 120 is set for the axle being pulled to a tensile limit 202 of between four degrees and five degrees steering angle difference 120. As a result, the turning circle 122 can be reduced to less than 9.6 meters compared to Ackermann 200, for example.

In particular, the axle being pulled is a steerable front axle of a rear-wheel drive vehicle. The reduction of the turning circle 122 is then within the range 204 of a possible reduction of the turning circle 122 due to a steerable rear axle.

In one exemplary embodiment, the steering angle difference 120 is decreased for the axle being pushed to a thrust limit 206, for example, seven degrees steering angle difference 120 compared to Ackermann 200. As a result, a reduction of the turning circle 120 to about 9.8 meters can also be achieved for the axle being pushed.

Possible embodiments of the invention are summarized again below or presented with a slightly different choice of words.

An operating strategy for a direction-dependent steering difference angle selection for individual wheel steering actuators when parking is presented.

Modern vehicles are equipped with electromechanical steering connected to both wheels. The development of steering systems is moving more and more in the direction of by-wire systems that are mechanically decoupled from the driver, i.e. the classic mechanical connection between the driver and the wheels themselves is no longer necessary. In the case of the steering, the respective actuation takes place purely via one or more actuators. Central but also decentralized by-wire steering adjusters are already prior art for the rear axle (ZF: AKC). The first prototype vehicles with by-wire single wheel steering actuators (SWS) for the front axle, such as the research vehicle SpeedE, are well-known.

For by-wire steering systems with a central actuator, the steering difference angle curve is predetermined by the steering kinematics due to the mechanical coupling of the left and right wheels. For vehicles with steer-by-wire systems with individual wheel steering actuators, the left-right wheel steering angle can be freely selected within limits.

The approach presented herein discloses an intelligent operational strategy in parking for advantageous steering difference angle settings between left and right wheels. However, with conventional central steering angle adjusters (also in by-wire systems), there is no possibility of influence. In addition, simply maximizing the internal and external wheel steering angle, which indeed leads to a turning circle reduction, is not always expedient. Although parallel steering of the two wheels results in a turning circle reduction, the driver has a negative perception of the driving feel and tire behavior due to the non-ideal rolling of the tires around the instantaneous center of rotation when cornering with a defined radius. The operating strategy presented here results in a significantly better drivability. It has already been shown experimentally that the procedure proposed here is effective.

Essentially, the feature presented utilizes the possibility of any steering difference angle with an existing individual wheel steering actuator system on the front axle. This is one of the essential properties from which a situationally advantageous system behavior can be generated. In the approach presented here, this is done in a direction-dependent manner, which offers advantages in terms of drivability.

The most energy-efficient and tire-friendly design of the steering differential angle is the well-known design according to Ackermann, in which both wheels can roll on their respective circular paths without slipping. A slight deviation from Ackermann is already common with central steering actuators. Existing individual wheel steering actuators allow activation of an auxiliary wheel steering angle and reduction of the turning circle by parallel steering.

In the approach presented herein, there is a distinction between forward and reverse travel. A distinction is thus made depending on the direction of travel in the maximum allowable reduction of the steering difference angle, wherein 0° corresponds to parallel steering with identical steering angle on the right and left. The maximum wheel steering angle is not changed.

Parallel steering with individual wheel steering actuators reduces the turning circle approximately as much (in the range) as rear axle steering with 3 to 4°. However, this also affects the rolling of the tire on the outside of the bend, which is forced to a smaller radius than it is aiming for. The deformation and wear of the tire are increased for forward travel in combination with the camber profile when turning the wheel.

In FIG. 2, the turning circle reduction by steering difference angle reduction, as well as limits of the forward and reverse travel approach presented herein, are shown. For comparison, a turning circle reduction when using a rear axle steering is shown.

In the approach presented here, parallel steering or a rather low steering difference angle is therefore only used for rear parking/maneuvering. With rear-wheel drive, the wheel is pulled through the bend. For forward travel, steering angle differences are used in a correspondingly slight gradation with a certain steering difference angle smaller than in an Ackermann design but greater than 0°. This allows the possibility of turning circle reduction with individual wheel actuators to be used, but the driving feel is not negatively influenced.

Different travel directions and drive topologies may be combined with different steering difference angle curves. Furthermore, positioning of the engine may also be included. Thus, in an arrangement of the drive on the rear axle, reverse travel with parallel steering is advantageous compared with forward travel with parallel steering.

With all-wheel drive, the drive torque distribution for parking can be selected so that the rear axle is mainly or completely driven for reverse travel. For forward travel, the front axle may be driven primarily or completely.

In addition, a corresponding left-right longitudinal torque distribution (“torque vectoring”) can be used, which supports turning in the desired direction and prevents or reduces sliding or deformation of the wheel on the outside of the bend. This may be done by braking a wheel accordingly. For example, for forward travel, the rear wheel on the inside of the bend may be slightly braked to assist turning. Alternatively or in addition, targeted drive torque interventions are possible to reduce the actuator forces (“steer-by-drive”/“steer-by-brake”). These interventions could be used for braking/driving depending on the direction and depending on the steering roll radius or interference force lever arm in order to turn the wheel.

Lastly, it should be noted that terms such as “comprising”, “including”, etc. do not exclude other elements or steps and terms such as “one” or “a” do not exclude a plurality. Reference signs in the claims should not be construed as limitations.

1. A steering assistance method for a vehicle that includes individual wheel steering actuators, the method comprising:
setting a steering angle difference between a wheel on the inside of the bend and a wheel on the outside of the bend of an axle of the vehicle to be smaller in a driving mode in which the axle is being pulled than in a driving mode in which the axle is being pushed.

2. The steering assistance method according to claim 1, wherein the steering angle difference is set to be smaller than in a steering configuration where the steering angle difference is optimized for rolling the wheel on the inside of the bend and the wheel on the outside of the bend with minimum slippage on circular tracks around an instantaneous center of rotation of the vehicle.

3. The steering assistance method according to claim 1, wherein a drive balance of the vehicle is set such that an axle of the vehicle being pulled is driven less than an axle of the vehicle being pushed.

4. The steering assistance method according to claim 1, wherein the steering angle difference is set dependent on speed.

5. The steering assistance method according to claim 4, wherein the steering angle difference is set when a speed of the vehicle is less than a predetermined slow travel value.

6. The steering assistance method according to claim 1, wherein furthermore a longitudinal torque difference is set between a wheel on the inside of the bend of the axle and a wheel on the outside of the bend of the axle on at least one axis of the vehicle.

7. The steering assistance method according to claim 6, wherein the longitudinal torque difference is set on a different axis than the steering angle difference.

8. The steering assistance method according to claim 6, wherein the longitudinal torque difference is set by a braking torque applied to the wheel on the inside of the bend.

9. The steering assistance method according to claim 6, wherein the longitudinal torque difference is set by a drive torque applied to the wheel on the outside of the bend.

10. A control device, wherein the control device is configured to execute, implement and/or control the steering assistance method according to claim 1 in corresponding devices.

11. A motor vehicle, having a control device according to claim 10.

12. A computer program product which is configured to direct a processor to execute, implement and/or control the steering assistance method according to claim 1 when said computer program product is executed.

13. A machine-readable storage medium on which the computer program product according to claim 12 is stored.
